(19) United States
(12) Patent Application Publication
(10) Pub. No.: US 2010/0180200 A1
(43) Pub. Date: Jul. 15, 2010

(54) ELECTRONIC ASSISTANT

(76) Inventors: THIERRY DONNEAU-GOLENCER, Menlo Park, CA (US); Stephen Hardt, Redwood City, CA (US); Christopher Adam Overholtzer, Menlo Park, CA (US); Kenneth Nitz, Redwood City, CA (US)

Correspondence Address: Wall & Tong, LLP;SRI INTERNATIONAL, 595 SHREWSBURY AVENUE, SHREWSBURY, NJ, 07702, US

(21) Appl. No.: 12/632,491

(22) Filed: Dec. 7, 2009

Related U.S. Application Data
(60) Provisional application No. 61/144,117, filed on Jan. 12, 2009.
(60) Provisional application No. 61/219,259, filed on Jun. 22, 2009.

(51) Int. Cl. G06F 3/048

(52) U.S. Cl. 715/705

(57) ABSTRACT

The present invention relates to an electronic assistant. In one embodiment, a system for assisting with a current workflow being performed on a computing device includes a watcher for extracting a context from the current workflow, a harvester for identifying at least one document associated with a concept that matches the context, and a suggestion generator for displaying the document to the user of the computing device, where the document is suggested to aid the user in performing the current workflow.

### CROSS REFERENCE TO RELATED APPLICATIONS

This application claims the benefit of U.S. Provisional Patent Application No. 61/144,117, filed Jan. 12, 2009 and U.S. Provisional Patent Application No. 61/219,259, filed Jun. 22, 2009, both of which are herein incorporated by reference in their entireties.

### REFERENCE TO GOVERNMENT FUNDING

This invention was made with Government support under contract number NBCHD030010 awarded by the Department of Interior/National Business Center and contract number FA8750-07-D-0185 awarded by the Air Force Research Laboratory. The Government has certain rights in this invention.

### FIELD OF THE INVENTION

The present invention relates generally to data management, and relates more particularly to technology for assisting in data management.

### BACKGROUND OF THE INVENTION

Much of the work professionals do on computers is about “connecting” things. For instance, creating a set of slides (e.g., for a presentation) involves finding and rearranging existing material spread across other sources (e.g., other presentations, other applications, the World Wide Web). Corresponding by email involves similar tasks. For instance, when responding to an email, one often needs information contained in another source (e.g., another email, a calendar application, a file). In other words, one needs to connect something (e.g., a presentation, an email) with other things (e.g., other presentations, other emails, files, World Wide Web resources).

Connecting things in this manner is typically a manual process. It is user-initiated, user-executed, tedious, repetitive, and time-consuming. Often, several searches must be executed and several applications must be opened before the appropriate connections can be made. Unfortunately, searches are expensive, and one often keeps searching for the same things.

### SUMMARY OF THE INVENTION

The present invention relates to an electronic assistant. In one embodiment, a system for assisting with a current workflow being performed on a computing device includes a watcher for extracting a context from the current workflow, a harvester for identifying at least one document associated with a concept that matches the context, and a suggestion generator for displaying the document to the user of the computing device, where the document is suggested to aid the user in performing the current workflow.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of an electronic assistant, according to the present invention;

FIG. 2 is a flow diagram illustrating one embodiment of a method for providing electronic assistance, according to the present invention;

FIG. 3 illustrates a first exemplary deskbar that may be displayed on a user's desktop, according to the present invention;

FIG. 4 illustrates a second exemplary deskbar that may be displayed on a user's desktop, according to the present invention;

FIG. 5 is a flow diagram illustrating one embodiment of a method for assembling a set of documents, according to the present invention; and

FIG. 6 is a high level block diagram of the present invention implemented using a general purpose computing device.

To facilitate understanding, identical reference numerals have been used, where possible, to designate identical elements that are common to the figures.

### DETAILED DESCRIPTION

The present invention relates to an electronic assistant. Embodiments of the electronic assistant actively help connect documents and email activity on a user's desktop by providing helpful suggestions based on a current context and activity, previous contexts and activities, document analysis, and learned user models. Embodiments of the electronic assistant run constantly on the desktop and provide helpful suggestions regarding documents and possible actions related to a user's current task. Thus, the electronic assistant is part discovery tool and part suggestion tool. It is context-aware, action-oriented, and memory-enhanced. The electronic assistant can be accessed through multiple user interfaces including a deskbar, a floating deskbar, and a desktop widget.

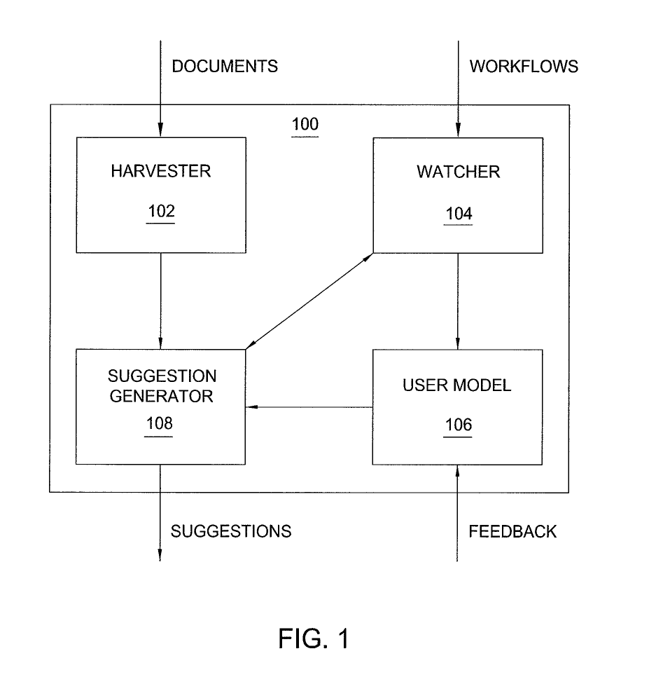

FIG. 1 is a schematic diagram illustrating one embodiment of an electronic assistant 100, according to the present invention. In one embodiment, the electronic assistant 100 operates substantially continuously in the background of the user's desktop. As illustrated, the main components of the electronic assistant 100 are a harvester 102, a watcher 104, a user model 106, and a suggestion generator 108.

The harvester 102 indexes and processes documents including files (e.g., word processing files, spreadsheet files, presentation files, individual slides in presentation files, etc.), calendar events, to do lists, notes, emails, and email attachments. These documents may be retrieved locally from the user's computer and/or remotely from network storage (e.g., a server that stores documents produced by a plurality of users). In the latter case, the harvester 102 may also retrieve documents from the World Wide Web (e.g., web pages). As discussed in further detail below, harvested documents are clustered into concepts. Concepts may include, for example, projects, tasks, or groups. This clustering may be based, for example, on document analysis, semantic extraction, user activity, tags, search queries, folder names, most important word, and/or user feedback. These concepts may become “hotter” (more relevant) or “colder” (less relevant) based on user activity (e.g., user interaction with documents).

The watcher 104 monitors the user's current workflows. That is, the watcher 104 tracks what the user is doing on his desktop (e.g., creating a presentation, writing an email, etc.). The watcher 104 monitors the workflows, which define a context (based on user activities) for making suggestions. Thus, the context may be considered as a “trigger” that indicates when it might be appropriate to make a suggestion to the user. Context also triggers certain concepts, as discussed above (e.g., causes certain concepts to become hotter or colder). User activities that define contexts may include, for example, accessing or editing a document or sending or receiving an email.

The user model 106 communicates with the watcher 104 in order to build a profile of the user's behavior and preferences. This profile may be informed, for example, by the user's workflows and the actions taken by the user in accordance with those workflows.

The suggestion generator 108 receives information from the harvester 102, the watcher 104, and the user model 106 and uses this information in order to produce suggestions. The suggestions comprise recommendations intended to aid the user in his current workflow. For example, if user is currently writing an email, the suggestion generator 108 may suggest one or more documents to be attached to the email. If the user is currently creating a slide for a presentation, the suggestion generator 108 may suggest one or more spreadsheets containing information that is relevant to the slide.

The electronic assistant 100 also receives feedback from the user regarding the suggestions that are made. This feedback is used to refine the user model 106, so that future suggestions can be better tailored to the user's preferences.

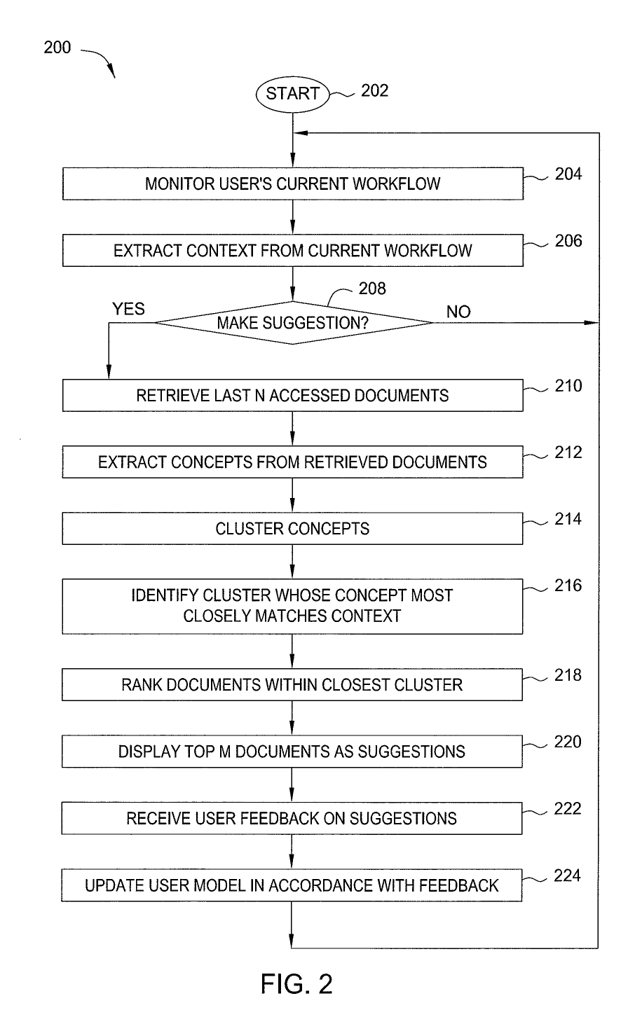

FIG. 2 is a flow diagram illustrating one embodiment of a method 200 for providing electronic assistance, according to the present invention. The method 200 may be implemented, for example, by the electronic assistant 100 illustrated in FIG. 1. As such, reference is made in the discussion of the method 200 to various components of the electronic assistant 100. However, it is noted that the method 200 is not limited to implementation by an electronic assistant configured in accordance with FIG. 1 and may, in fact, be implemented by electronic assistants having alternative configurations and components.

The method 200 is initialized at step 202 and proceeds to step 204, where the watcher 104 monitors a user's current workflow. In step 206, the watcher 104 extracts a context from the user's current workflow. As described above, the context is based on the user's current workflow and activities (e.g., accessing or editing a document, sending or receiving an email). In one embodiment, the context is extracted by analyzing the last Y (e.g., five) documents accessed by the user (e.g., for most important words, tags, or the like).

In step 208, the suggestion generator 108 determines whether it is appropriate to make a suggestion to the user. In one embodiment, the suggestion generator 108 automatically runs the following process (i.e., embodied in steps 210-220) on a periodic basis (e.g., every x seconds). In another embodiment, the suggestion generator 108 runs the following process in response to a trigger being detected in the user's current workflow. The trigger may be, for instance, the user opening a new document, the user closing a document, the user editing a document, the user reading an email, the user responding to an email, the user accessing a calendar application, the user accessing a Web page, the user providing feedback in response to a document suggested by the electronic assistant 100, or the user executing an action suggested by the electronic assistant 100.

In step 210, the harvester 102 retrieves the last N accessed documents. In one embodiment, the last N accessed documents are the last N documents accessed by the user from local storage. In another embodiment, the last N accessed documents are the last N documents accessed by all users from shared or remote storage (e.g., a World Wide Web server, or a company server that the user shares with others).

In step 212, the harvester 102 extracts concepts from the retrieved documents, as discussed above. Concepts may represent, for example, projects, tasks, or groups. In step 214, the harvester 102 clusters these concepts. In one embodiment, clustering is based on at least one of: document analysis, semantic extraction, user activity, tags, search queries, folder names, most important words, or user feedback. The resultant clusters embody the extracted concepts. A single retrieved document may belong to multiple clusters.

In step 216, the suggestion generator 108 identifies the cluster (or clusters) whose corresponding concept most closely matches the context extracted by the watcher 104. The suggestion manager 108 then ranks the documents within the closest cluster in step 218. In one embodiment, the documents are ranked according to one or more of: time created, last time modified, last time accessed, similarity, anti-similarity, or learning.

In step 220, the suggestion generator 108 outputs or displays the top M ranked documents in the cluster to the user as suggested documents. In one embodiment, a diversity algorithm is applied in order to identify the top M ranked documents. In one embodiment, the relevance of a particular document to a context is determined in accordance with at least one of: text, most important words, extracted semantic information (e.g., names, locations, times), authors, creation dates, last access dates, last edit dates, document histories, document lengths, images, graphics, titles, tables, bullet points, paragraphs, fonts, colors, layouts, folder names, location paths, owners, file types, tags, or similar documents. In one embodiment, the relevance of an email to a context is determined in accordance with at least one of: senders, primary recipients, carbon copy recipients, blind carbon copy recipients, subject, requests or questions, feedback request keywords (e.g., “reply,” “answer,” “let me know”), links, topics, tags, threads, responses, or forwards.

In one embodiment, the suggested documents are presented to the user via a widget or pop up graphic that lists the suggested documents. In another embodiment, the suggested documents are presented to the user via a deskbar that is always displayed on the desktop. In one embodiment, an association between the current workflow and the suggested documents is stored by the electronic assistant 100; thus, the electronic assistant 100 “remembers” connections.

In step 222, the user model 106 receives feedback from the user regarding the suggested documents. In one embodiment, the feedback comprises an indication as to whether the user has accepted or rejected a particular suggested document. The user model 106 then updates itself in step 224 based on the feedback. Once the user model 106 is updated, the method 200 returns to step 204, where the watcher continues to monitor the current workflow.

In one embodiment, the electronic assistant 100 is trained on the method 200 at install, using documents accessed in the last X days.

The electronic assistant 100 thus finds documents related to the user's current workflow. For example, as the user begins to compose an email, the electronic assistant 100 may suggest other documents that will help compose the email, such as previous emails in the email thread, a presentation related to the content of the email, or other relevant documents. If the user switches to composing a proposal (e.g., in a slideshow application, a word processing application, or other application), the electronic assistant 100 identifies the theme of the proposal and may instead suggest documents and emails related to the proposal, such as an email containing the last comments received from a coworker. As discussed above, the desktop assistant 100 may be implemented as a widget or a deskbar, so that it is displayed only when the user wants it to be displayed.

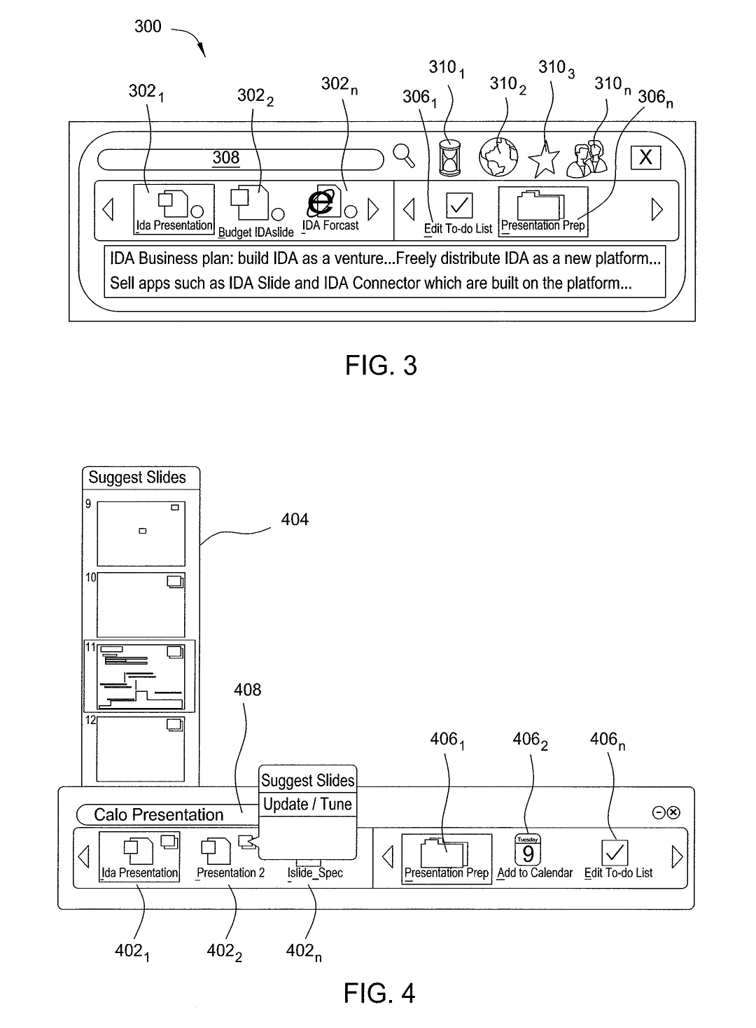

As discussed above, in one embodiment, a suggestion made by the suggestion manager 108 may be made using a deskbar or widget. FIG. 3, for example, illustrates a first exemplary deskbar 300 that may be displayed on a user's desktop, according to the present invention. The deskbar 300 may be used in conjunction with the method 200 to suggest documents or actions to a user.

As illustrated, the deskbar 300 displays a plurality of document shortcuts 30Z₁-302ₙ (hereinafter collectively referred to as “document shortcuts 302”) to suggested local documents. In one embodiment, the document shortcuts 302 are presented as a navigable list through which the user can scroll. In one embodiment, at least some of the contents of the suggested documents may be inserted directly into the user's current workflow by simply dragging the associated document shortcut 302 and dropping it into the current workflow.

In one embodiment, the deskbar 300 also comprises an excerpt box 304. When a shortcut 302 is highlighted by the user, the deskbar 300 displays an excerpt of the associated document in the excerpt box 304, as illustrated.

In one embodiment, the deskbar 300 also comprises a plurality of action shortcuts 306₁-306ₙ (hereinafter collectively referred to as “action shortcuts 306”) to suggested actions. For example, a to do shortcut 306₁ displays the user's to do list (e.g., in an additional frame of the deskbar 300) and allows the user to edit the to do list. An entry in the to do list may include a shortcut to an associated document. A presentation preparation shortcut 306ₙ allows the user to create a new presentation (e.g., a new slideshow). Like the document shortcuts 302, the action shortcuts 306 may be presented as a navigable list through which the user can scroll.

In one embodiment, the deskbar 300 comprises a search bar 308 that allows the user to enter a keyword search or a natural language search. For instance, the user may enter a keyword into the search box 308 in order to initiate a new query or in order to filter the suggested documents and/or actions.

In one embodiment, the deskbar 300 comprises a plurality of discovery tools 310₁-310ₙ (hereinafter collectively referred to as “discovery tools 310”). Each of the discovery tools 310 allows the user to view further information about suggested documents. This further information may be displayed in an additional window of the deskbar 300. For example, an hourglass discovery tool 310₁ allows the user to view a list of the n documents that were most recently accessed (e.g., by the user and/or by others). In one embodiment, the list is sorted according to time of last access. A Web discovery tool 310₂ allows the user to view one or more suggested documents that were retrieved from the World Wide Web. In one embodiment, selection of a particular suggested document from the World Wide Web causes the deskbar 300 to display a thumbnail of the suggested document and/or an excerpt from the suggested document. A favorites discovery tool 310₃ allows the user to view a list of n suggested documents that have been marked by the user as favorites. A friends discovery tool 310ₙ allows the user to view a list of n suggested documents that have been created or updated by others (e.g., the user's friends or colleagues).

FIG. 4 illustrates a second exemplary deskbar 400 that may be displayed on a user's desktop, according to the present invention. In particular, the deskbar 400 may be used in conjunction with the method 200 to help create a new slide for a slideshow presentation. The deskbar 400 may be used to gather documents, discover new slides, or tune existing slides.

As illustrated, the deskbar 400 displays a plurality of document shortcuts 402₁-402ₙ (hereinafter collectively referred to as “document shortcuts 302”) to suggested local documents. In one embodiment, the document shortcuts 302 are presented as a navigable list through which the user can scroll. In one embodiment, at least some of the contents of the suggested documents may be inserted directly into a new slide by simply dragging the associated document shortcut 302 and dropping it into the new slide.

In one embodiment, the deskbar 300 also comprises an excerpt box 404. When a shortcut 402 is highlighted by the user, the deskbar 400 displays an excerpt of the associated document in the excerpt box 404, as illustrated. In the illustrated case, where the highlighted shortcut relates to a slideshow presentation, the excerpt box 404 displays one or more of the slides in the slideshow presentation.

In one embodiment, the deskbar 400 also comprises a plurality of action shortcuts 406₁-406ₙ (hereinafter collectively referred to as “action shortcuts 406”) to suggested actions. For example, a presentation preparation shortcut 406₁ allows the user to package a set of related documents together. An add to calendar shortcut 406₂ allows the user to add an entry to the user's calendar application. An entry in the calendar application may include a shortcut to an associated document (e.g., a presentation to be given at a scheduled meeting). A to do shortcut 306ₙ displays the user's to do list (e.g., in an additional frame of the deskbar 400) and allows the user to edit the to do list. An entry in the to do list may include a shortcut to an associated document.

In one embodiment, the deskbar 400 comprises a search bar 408 that allows the user to enter a keyword search or a natural language search. For instance, the user may enter a keyword into the search box 408 in order to initiate a new query or in order to filter the suggested documents and/or actions.

As discussed above, the deskbar 400 may be used to create a new presentation or to tune an existing presentation. For example, the user can start from scratch by using the deskbar 400 to gather relevant material from local or remote storage (e.g., from other presentations, emails, documents, etc.). Alternatively, the user could use the deskbar 400 to “fill in the gaps” with additional relevant material when he has already created a portion of the presentation.

The deskbar 400 can also be used to tune an existing presentation, for example by making suggestions to help shorten the presentation, to modify the presentation (e.g., to focus on a topic, to make more or less technical, etc.), or to update data contained therein (e.g., graphs, charts, figures, etc.).

Embodiments of the present electronic assistant are configured to deliver to the user a set of related documents based on some triggering event or document. For example, if the electronic assistant detects that the user has added an entry for interviewing a job applicant in/to his calendar application, the electronic assistant may deliver a set of documents including emails, resumes, writing samples, references, transcripts, and the like that are related to the purpose of the meeting.

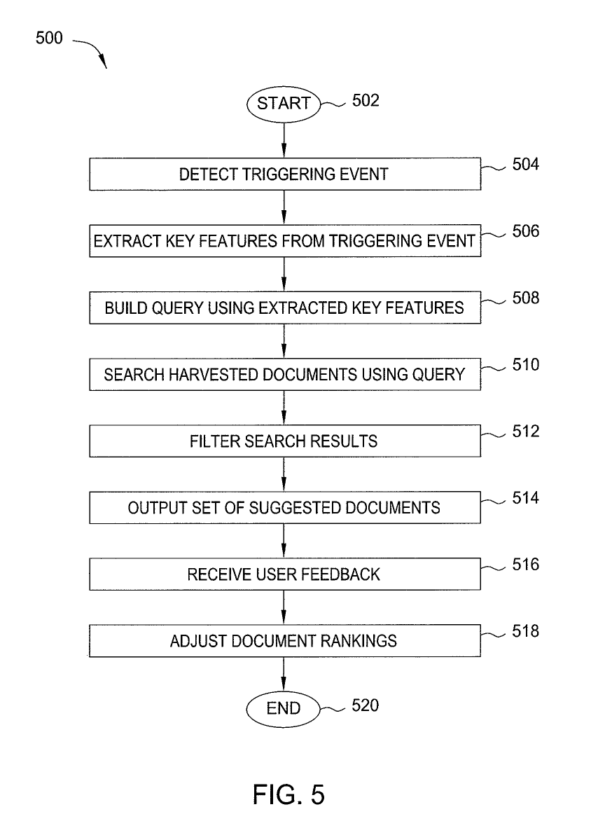

FIG. 5 is a flow diagram illustrating one embodiment of a method 500 for assembling a set of documents, according to the present invention. The method 500 may be implemented, for example, in conjunction with the method 200 in order to recommend a set of documents related to a triggering event. Thus, the method 500 may be implemented by the electronic assistant 100 illustrated in FIG. 1. As such, reference is made in the discussion of the method 500 to various components of the electronic assistant 100. However, it is noted that the method 500 is not limited to implementation by an electronic assistant configured in accordance with FIG. 1 and may, in fact, be implemented by electronic assistants having alternative configurations and components.

The method 500 is initialized in step 502 and proceeds to step 504, where the watcher 104 detects a triggering event. The triggering event may be, for example, an entry in a calendar application, a business trip, an interview of a job candidate, proposal activity, review of a technical paper, or the like. The triggering event may also be a document (e.g., an email received or sent, a newly created or edited word processing document, etc.).

In step 506, the suggestion generator 108 extracts one or more key features from the triggering event. In one embodiment, these key features include one or more of: keywords, people, dates, locations, or acronyms. In one embodiment, stop words (e.g., “a,” “the,” etc.) in the triggering event are discarded. In one embodiment, an information or semantic extraction technique is used to extract the key features.

In step 508, the suggestion generator builds a query using the extracted key features. In one embodiment, the query assigns a weight to each of the extracted key features.

In step 510, the suggestion generator 108 performs a search on harvested documents that have been harvested by the harvester 102, using the query built in step 508. In one embodiment, the query is run against a Lucene full text query (FTQ) over the harvested documents. The search results comprise a ranked list of harvested documents based upon the words and document frequency.

In one embodiment, the harvested documents are ranked according to at least one of: recency, word popularity, and learning. In one embodiment, initial rankings of the harvested documents (i.e., as initially output by the search) are based on recency and word popularity. Rankings based on learning rely on user feedback, as discussed in further detail below.

Recency rankings assign higher weights to documents that have later modified dates, access dates. In one embodiment, recency rankings also account for the number of times that a document has been accessed.

Word popularity rankings are based on a global dictionary that contains high-frequency words and associated weights. The number of high-frequency words is user-configurable and may be limited, for example, to fifty thousand words. When a new document is harvested, keywords that do not exist in the global dictionary may be added to the global dictionary. Weights are constantly updated based on workflow (e.g., keywords in frequently accessed documents may have their weights increased, while keywords in less frequently accessed documents have their weights decreased).

In step 512, the suggestion generator 108 filters the search results. In one embodiment, a template is used to perform the filtering. The template is customized for the triggering event. The idea behind the template is that for certain events and documents, a user will typically require the same types of documents. For example, if the user is interviewing a job candidate, the user will typically require one or more of: the candidate's resume, the time of the interview, copies of published work written by the candidate, or the like. In one embodiment, the user model 106 stores the templates.

In one embodiment, the appropriate template for a triggering event is determined by classifying the triggering event's activity type based on the key features (e.g., using a maximum entropy classifier). The appropriate template may then be located, for example, from a hash table by using the activity type as a key. In one embodiment, harvested documents that match a triggering event are identified in a similar manner. A document's activity type is classified based on the key features (e.g., using a maximum entropy classifier). The document's activity type is then compared to the document activity type required by the template associated with the triggering event. The ranking of documents whose activity type match the document activity type required by the template are increased, while the rankings of documents whose activity type does not match the document activity type required by the template are decreased.

In step 514, the suggestion generator 108 outputs the filtered search results to the user as a set of suggested documents. In step 516, the suggestion generator 108 receives user feedback relating to the set of suggested documents. The user feedback may be explicit (e.g., “Keep this document in the suggested set” or “Remove this document from the suggested set”) or implicit (e.g., the user opens a document, the document's folder, or asks for similar documents).

The method 500 then proceeds to step 518 and adjusts the rankings of the documents, in accordance with the user feedback. The adjusted rankings may be stored, for example, by the user model 106. The method 500 then terminates in step 520.

As discussed above, the user feedback may be explicit. Updates to the global dictionary at the word level may reflect this feedback; however, learning applies at the document level. In one embodiment, each suggested document retains a signature of the triggering event and an indication as to whether the user feedback was positive or negative. If the document is later returned in the search results for another search, the signature of the later triggering event can be compared to the signature retained by the document. If the signatures match, the ranking of the document may be increased or decreased depending on whether the retained indication of user feedback is positive or negative. Implicit feedback may be accounted for in a similar manner; however, in one embodiment, the weight associated with implicit feedback is lower than the weight associated with explicit feedback. As a result, a document's ranking is likely to be less affected (i.e., the change is smaller) by implicit feedback.

In one embodiment, the suggestion generator 108 is pre-trained to recognize certain document or activity types and their associated templates (e.g., such as for activity types including travel, car rental, hotel reservations, airline reservations, budget, or the like).

The suggestion generator 108 can also be trained to recognize new document and activity types and their associated templates. In this case, the suggestion generator 108 would break the triggering event into words and word types (e.g., date, time, names, etc.), for example using an information or semantic extraction technique (wherein stop words are optionally removed). These words, along with an “activity type” label, are then used as training data for a classifier that is used to determine document type (e.g., a maximum entropy classifier), and the new classifier is then stored.

New documents of a known document or activity type can also be learned by re-training an activity type classifier. In this case, a document is broken into words and word types (e.g., date, time, names, etc.), for example using an information or semantic extraction technique (wherein stop words are optionally removed). These words, along with an “activity type” label, are then used as training data for a classifier that is used to determine document type (e.g., a maximum entropy classifier), and the new classifier is then stored.

The electronic assistant of the present invention therefore facilitates the creation or modification of documents by “connecting” new documents to relevant existing documents that may contain useful information. The electronic assistant autonomously performs discovery so that it may locate and suggest relevant documents. The user therefore does not need to spend time manually searching for relevant documents. Furthermore, unlike traditional search features, the electronic assistant of the present invention is context-aware. Thus, the search results and suggestions are narrowly focused to the task at hand. The electronic assistant is also action-oriented, meaning that the user does not have to actively engage the electronic assistant in order to solicit suggestions; the embodiments of the electronic assistant run continuously in the background of the user's desktop. Finally, the electronic assistant can save its discovery results, as well as the feedback received from the user, to inform future suggestions.

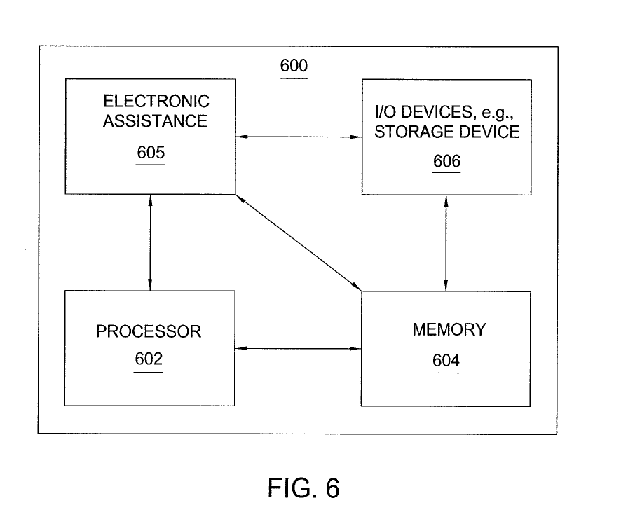

FIG. 6 is a high level block diagram of the present invention implemented using a general purpose computing device 600. It should be understood that embodiments of the invention can be implemented as a physical device or subsystem that is coupled to a processor through a communication channel. Therefore, in one embodiment, a general purpose computing device 600 comprises a processor 602, a memory 604, an electronic assistance module 605, and various input/output (I/O) devices 606 such as a display, a keyboard, a mouse, a modem, and the like. In one embodiment, at least one I/O device is a storage device (e.g., a disk drive, an optical disk drive, a floppy disk drive).

Alternatively, embodiments of the present invention (e.g., electronic assistance module 605) can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the electronic assistance module 605 for providing helpful suggestions regarding documents and possible actions related to a user's current task described herein with reference to the preceding Figures can be stored on a computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A method for assisting with a current workflow being performed on a computing device, the method comprising:
extracting a context from the current workflow;
identifying at least one document associated with a concept that matches the context; and
displaying the at least one document to a user of the computing device, where the at least one document is suggested to aid the user in performing the current workflow.

2. The method of claim 1, wherein the extracting comprises:
analyzing a set number of documents last accessed by the user; and
identifying the context based on contents of the set number of documents.

3. The method of claim 2, wherein the contents comprise at least one of:
one or more words or one or more tags.

4. The method of claim 1, wherein the identifying comprises:
retrieving a set number of documents last accessed by the user;
clustering the set number of documents into one or more clusters;
extracting one or more concepts from the one or more clusters;
identifying a closest cluster whose associated concept most closely matches the context from among the one or more clusters; and
selecting the at least one document from the closest cluster.

5. The method of claim 4, wherein the selecting comprises:
ranking all of the set number of documents that are contained within the closest cluster to produce a ranked list; and
selecting a number of top-ranked documents from the ranked list.

6. The method of claim 1, wherein the at least one document is identified at least partly in accordance with a user model that models one or more preferences of the user.

7. The method of claim 1, further comprising:
receiving feedback from the user regarding the at least one document; and
updating the user model in accordance with the feedback.

8. The method of claim 1, wherein the method is triggered by a triggering event.

9. The method of claim 8, wherein the triggering event is at least one of: the user opening a new document, the user closing a document, the user editing a document, the user reading an email, the user responding to an email, the user accessing a calendar application, the user accessing a Web page, or the user providing feedback to the method.

10. The method of claim 9, wherein the identifying comprises:
extracting one or more key features from the triggering event;
building a query based on the one or more key features;
searching a plurality of harvested documents based on the query; and
selecting the at least one suggested document based on results of the searching, where the results comprise a ranked list of one or more documents.

11. The method of claim 10, wherein the selecting comprises:
filtering the ranked list.

12. The method of claim 11, wherein the filtering comprises:
identifying a template that corresponds to the triggering event from among a plurality of templates, where the template is associated with an activity type; and
identifying those of the one or more documents having an activity type that matches the activity type associated with the template; and
increasing corresponding rankings for those of the one or more documents having an activity type that matches the activity type associated with the template.

13. The method of claim 12, further comprising:
decreasing corresponding rankings for those of the one or more documents having an activity type that does not match the activity type associated with the template.

14. The method of claim 10, wherein the one or more key features comprise:
at least one keyword, at least one date, at least one person, at least one location, or at least one acronym.

15. The method of claim 1, wherein the at least one document resides in local storage.

16. The method of claim 1, wherein the at least one document resides in remote storage.

17. The method of claim 1, wherein the displaying comprises displaying a shortcut to the at least one document.

18. The method of claim 1, wherein the extracting, the identifying, and the displaying are performed continuously in a background of a desktop of the computing device.

19. A computer readable storage medium containing an executable program for assisting with a current workflow being performed on a computing device, where the program performs the steps of:
extracting a context from the current workflow;
identifying at least one document associated with a concept that matches the context; and
displaying the at least one document to a user of the computing device, where the at least one document is suggested to aid the user in performing the current workflow.

20. A system for assisting with a current workflow being performed on a computing device, comprising:
a watcher for extracting a context from the current workflow;
a harvester for identifying at least one document associated with a concept that matches the context; and
a suggestion generator for displaying the at least one document to a user of the computing device, where the at least one document is suggested to aid the user in performing the current workflow.
